(19) United States
(12) Patent Application Publication
(10) Pub. No.: US 2005/0213156 A1
(43) Pub. Date: Sep. 29, 2005

(54) Method and apparatus for duplex printing using preview function

(75) Inventors: Jae-kyoo Kang, Yongin-si (KR); Man-chan Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/084,107

(22) Filed: Mar. 21, 2005

(30) Foreign Application Priority Data
Mar. 23, 2004 (KR) 10-2004-0019642

(51) Int. Cl. G06K 15/02; G06F 17/00

(52) U.S. Cl. 358/1.18; 715/527; 358/450

(57) ABSTRACT

A method and apparatus for duplex printing using a preview function by which a printer can set the printing locations on front and back pages on which duplex printing is to be performed using a preview image of the front and back pages, and then perform duplex printing. The method includes generating a preview image of front and back pages that are prepared by a user, setting printing locations on the front and back pages on which duplex printing is to be performed according to printing locations that a user designates using the preview image, coding images of the front and back pages and converting the coded data into bitmap image data, and duplex printing the bitmap image data.

### BACKGROUND OF THE INVENTION

This application claims the benefit under 35 U.S.C. §119(a) of Korean Patent Application No. 10-2004-0019642, filed in the Korean Intellectual Property Office on Mar. 23, 2004, the entire disclosure of which is hereby incorporated by reference.

1. Field of the Invention

The present invention relates to an image forming method and apparatus. More particularly, the present invention relates to a method and apparatus for duplex printing using a preview function.

2. Description of the Related Art

In general, printers convert documents that a user prepares using an application program into coded data, and print the coded data in a user-readable form on a printing sheet. With the development of such data processing and printing techniques, the printers can further have an additional function for printing data on both sides of the printing sheet when desired by the user.

FIGS. 1 and 2 are block diagrams of the general configuration of a conventional printer. The conventional printer generally includes an application program 200 which allows a user to prepare a document to be printed, and an image forming apparatus driver 210 which converts the contents of the document into coded data that can be read by a video controller 220. The video controller 220 converts the coded data into bitmap image data. The conventional printer further includes an engine controller 230 which transmits the bitmap image data to a printing unit 240 which is controlled by the controller 230, and the printing unit 240 which prints the bitmap image data on a printing sheet.

When duplex printing is performed using the conventional printer, printing is performed on the front and back pages of a printing sheet according to the printing locations of the pages as determined by an application program without allowing adjusting of the printing locations of the contents to be printed. Thus, it cannot be accurately determined by the user at which locations of the front and back pages of the printing sheet that the contents will be printed until the printing sheet on which duplex printing has been performed comes out. As a result, the user cannot set desired printing locations on the front and back pages of a printing sheet on which duplex printing is to be performed.

Accordingly, a need exists for a system and method of duplex printing that allows a user to set desired printing locations on the front and back pages of a printing sheet on which duplex printing is to be performed.

### SUMMARY OF THE INVENTION

The present invention substantially solves the above and other problems, and provides an image forming method and apparatus for duplex printing using a preview function by which, the front and back pages of a print sheet on which duplex printing is to be performed can be displayed as a preview image and a user can set duplex printing locations on the pages via the preview image.

According to an aspect of the present invention, an apparatus for duplex printing using a preview function is provided comprising a preview image output unit which outputs the front and back pages on which duplex printing is to be performed as a preview image, a printing location setter which sets duplex printing locations on the pages according to printing locations that a user designates using the preview image, a data converter which codes images of the pages having the set duplex printing locations, a video controller which converts the coded data into bitmap image data and outputs the bitmap image data, and a printing unit which duplex prints the bitmap image data.

It is preferable that the preview image output unit distinguishes and outputs the front and back pages on which duplex printing is to be performed as one preview image, or distinguishes and outputs the front and back pages on which duplex printing is to be performed as different preview images.

It is also preferable that the printing location setter sets the duplex printing locations on the front and back pages according to the printing locations of the preview image as moved by the user, or sets the duplex printing locations on the front and back pages according to the printing location values set by the user.

According to another aspect of the present invention, a method of duplex printing using a preview function is provided including the steps of generating a preview image of the front and back pages as prepared by a user, setting the printing locations on the front and back pages on which duplex printing is to be performed according to the printing locations that a user designates using the preview image, coding images of the pages and converting the coded data into bitmap image data, and duplex printing the bitmap image data.

It is preferable that the front and back pages on which duplex printing is to be performed are distinguished and generated as one preview image, or are distinguished and generated as different preview images.

It is also preferable that the duplex printing locations are set on the front and back pages according to the printing locations of the preview image as moved by the user, or are set on the front and back pages according to the printing location values set by the user.

According to still another aspect of the present invention, a computer-readable recording medium is provided on which a program is recorded to execute a method for duplex printing using a preview function in a computer.

### BRIEF DESCRIPTION OF THE DRAWINGS

The above and other features and advantages of the present invention will become more apparent by describing in detail exemplary embodiments thereof with reference to the attached drawings in which:

FIGS. 1 and 2 are block diagrams of a configuration of a conventional printer;

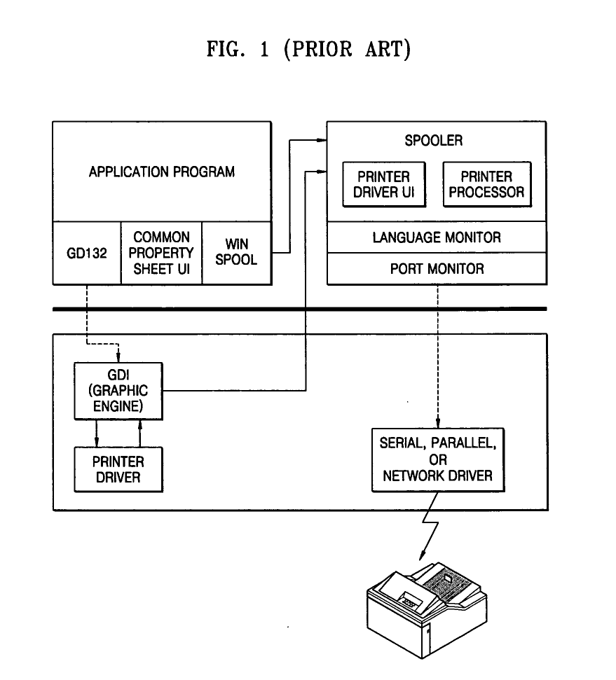

FIG. 3 is a block diagram of an exemplary configuration of an apparatus for duplex printing using a preview function according to an embodiment of the present invention;

FIG. 4 is a flowchart for illustrating a method of duplex printing using a preview function according to an embodiment of the present invention;

FIG. 5 is a flowchart for illustrating in greater detail step 420 of adjusting duplex printing locations on pages of a preview image according to an embodiment of the present invention;

FIG. 6 is a flowchart for illustrating in greater detail step 420 of adjusting duplex printing locations of pages of a preview image according to another embodiment of the present invention; and

FIG. 7 is a number of views for showing exemplary output preview images and adjusted duplex printing locations on pages.

Throughout the drawings, like reference numerals will be understood to refer to like parts, components and structures.

### DETAILED DESCRIPTION OF EXEMPLARY EMBODIMENTS

Hereinafter, exemplary embodiments of the present invention will be described in greater detail with reference to the attached drawings.

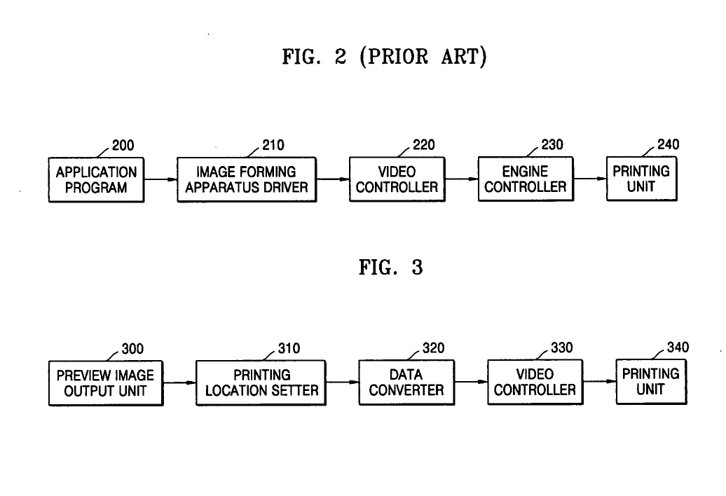

FIG. 3 is a block diagram of an exemplary configuration of an apparatus for duplex printing using a preview function according to an embodiment of the present invention. The apparatus includes a preview image output unit 300, a printing location setter 310, a data converter 320, a video controller 330, and a printing unit 340.

The preview image output unit 300 outputs pages which are prepared by a user using an application program and on which duplex printing is to be performed as a preview image. Here, the preview image output unit 300 may simultaneously output the front and back pages as one preview image on one screen, or may separately output the front and back pages each on one screen.

The printing location setter 310 sets the duplex printing locations according to printing locations that are designated by a user using the preview image output from the preview image output unit 300. Here, the user may set the printing locations of the front and back pages by moving the location of the output preview image, or set the printing locations of the front and back pages according to printing location values set by the user. The data converter 320 then converts contents that are written on the two pages, including the set printing locations, into coded data that can be read by the video controller 330 and outputs the coded data. The video controller 330 receives the coded data, converts the coded data into printable bitmap image data, and outputs the printable bitmap image data. The printing unit 340 then prints the bitmap image data on both sides of a printing sheet.

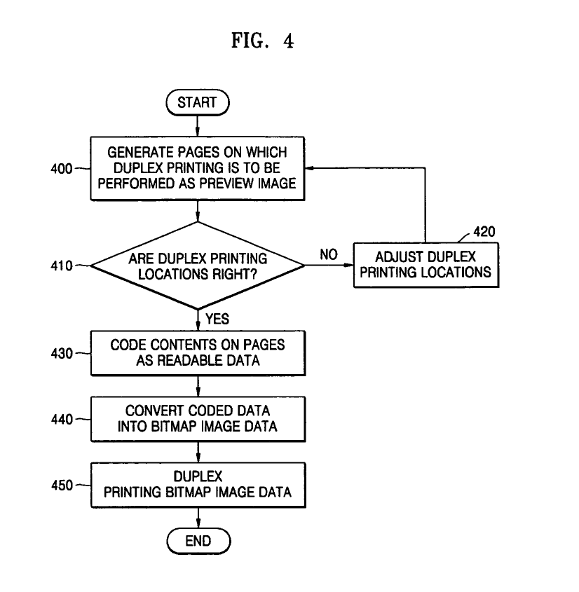

FIG. 4 is a flowchart for illustrating a method of duplex printing using a preview function according to an embodiment of the present invention. The method of FIG. 4 will be described in greater detail with reference to the apparatus of FIG. 3. Referring to FIG. 4, in step 400, the preview image output unit 300 outputs the front and back pages which are prepared by a user using an application program and on which duplex printing is to be performed as a preview image. In step 410, the printing location setter 310 determines via a key manipulation by the user, whether the duplex printing locations are correct on the preview image. When the printing location setter 310 determines that the duplex printing locations are not correct on the preview image, the printing location setter 310 adjusts the printing locations of the front and back pages on which duplex printing is to be performed according to the user's request in step 420. Steps 400, 410, and 420 are repeated until the duplex printing locations are correct on the preview images.

In step 430, the data converter 320 codes the images of the front and back pages into data that can be read by the video controller 330. In step 440, the video controller 330 converts the coded data into bitmap image data. In step 450, the printing unit 340 duplex prints the bitmap image data on a printing sheet.

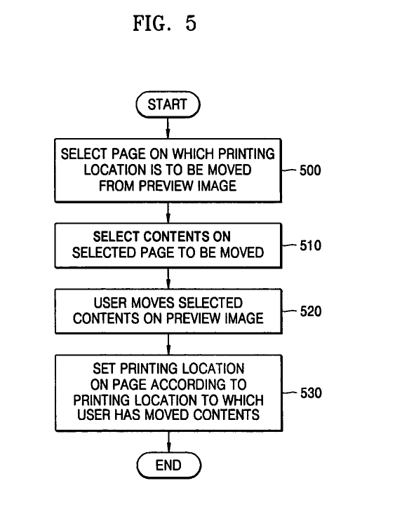

FIG. 5 is a flowchart for illustrating in greater detail step 420 for adjusting the duplex printing locations of front and back pages on a preview image according to an embodiment of the present invention. In step 500, a user selects a page on which a printing location is to be moved from the preview image output from the preview image output unit 300. In a case where the front and back pages on which duplex printing is to be performed are output as one preview image, step 500 may be omitted. In step 510, the user selects the contents, of which the printing locations are to be moved, on the selected page. In step 520, the selected contents are moved on the preview image by the user. In step 530, the printing location setter 310 then sets the printing location as moved by the user to a printing location.

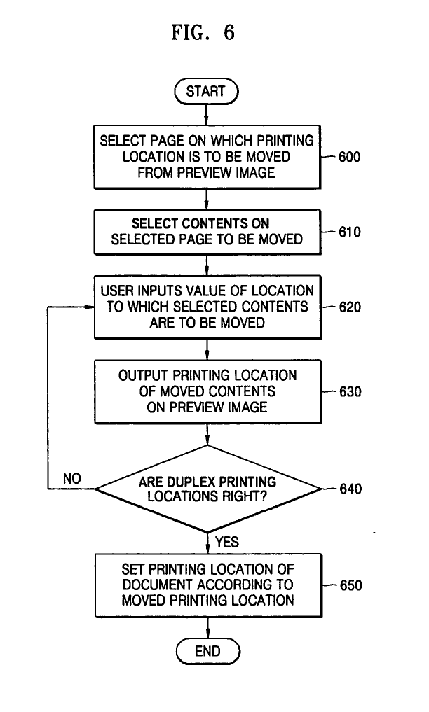

FIG. 6 is a flowchart for illustrating in greater detail step 420 for adjusting the duplex printing locations of front and back pages on a preview image according to another embodiment of the present invention. In step 600, a user selects a page on which a printing location is to be moved from the preview image output from the preview image output unit 300. In a case where the front and back pages on which duplex printing is to be performed are simultaneously output as one preview image, step 600 may be omitted. In step 610, the user selects the contents, of which the printing locations are to be moved, on the selected page.

In step 620, the user inputs a value (such as a coordinate value) of the location to which the selected contents are to be moved. In step 630, the preview image output unit 300 outputs a printing location of the moved contents on a preview image. In step 640, the printing location setter 310 determines whether moved duplex printing locations are correct on the pages. If in step 640, it is determined that the moved duplex printing locations are not correct on the pages, steps 620 and 630 are repeated until the duplex printing locations of the moved page are correct. In step 650, the printing location setter 310 then sets the printing location as moved by the user to a printing location.

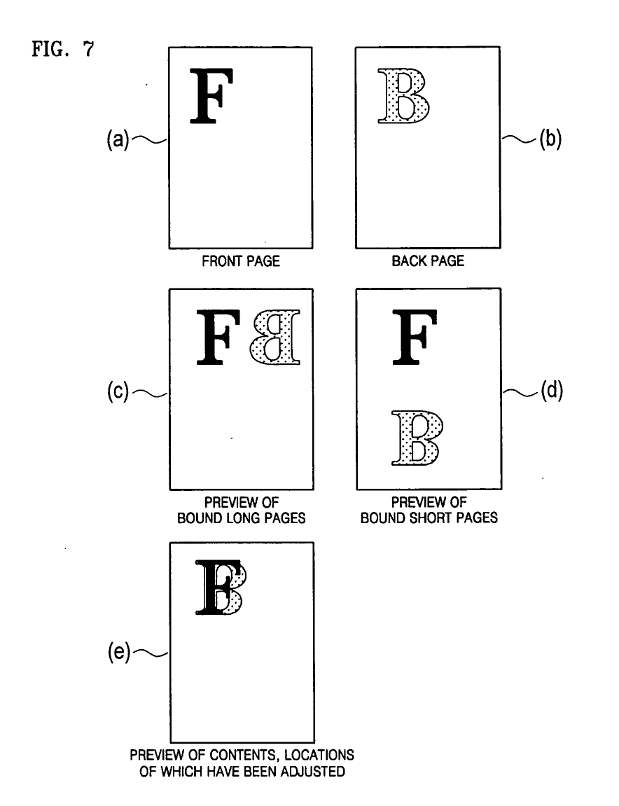

FIG. 7 is a number of views for showing output preview images and adjusted duplex printing locations on front and back pages. FIGS. 7(a) and 7(b) illustrate front and back pages, respectively, in distinguished and separate preview images. FIGS. 7(c) and 7(d) illustrate front and back pages in distinguished and combined preview images. Specifically, FIG. 7(c) is a preview of bound long pages, and FIG. 7(d) is a preview of bound short pages. FIG. 7(e) also illustrates front and back pages in a distinguished and combined preview image, including a preview of the contents of FIG. 7(d) wherein the locations of the contents have been adjusted.

As described above, in an exemplary method and apparatus for duplex printing using a preview function according to an embodiment of the present invention, front and back pages on which duplex printing is to be performed can be simultaneously displayed as one preview image so that a user can compare printing locations of the front and back pages on which substantial duplex printing is to be performed. When the duplex printing locations are not correct, the user can conveniently adjust the duplex printing locations using the preview function. Thus, the wear on the printing cartridge, and the time and effort wasted for printing a sheet or duplex printing due to wrong duplex printing locations can be reduced. As a result, the user can conveniently use only the necessary and desired duplex printed contents, as in the case of printing a business card.

The embodiments of the present invention can be written as computer programs and can be implemented in general-use digital computers that execute the programs using a computer readable recording medium. Examples of the computer readable recording medium include, but are not limited to, magnetic storage media (such s ROM, floppy disks, hard disks, and the like), optical recording media (such as CD-ROMs, or DVDs), and storage media such as carrier waves (such as transmission through the Internet).

While the present invention has been particularly shown and described with reference to exemplary embodiments thereof; it will be understood by those of ordinary skill in the art that various changes in form and details may be made therein without departing from the spirit and scope of the present invention as defined by the following claims and their equivalents.

1. An apparatus for duplex printing using a preview function, comprising:
a preview image output unit which outputs front and back pages on which duplex printing is to be performed as a preview image;
a printing location setter which sets duplex printing locations on the front and back pages according to printing locations designated using the preview image;
a data converter which codes images of the front and back pages having the set duplex printing locations;
a video controller which converts the coded data into bitmap image data and outputs the bitmap image data; and
a printing unit which duplex prints the bitmap image data.

2. The apparatus of claim 1, wherein the preview image output unit is configured to distinguish and output the front and back pages on which duplex printing is to be performed as one preview image.

3. The apparatus of claim 1, wherein the preview image output unit is configured to distinguish and output the front and back pages on which duplex printing is to be performed as different preview images.

4. The apparatus of claim 1, wherein the printing location setter is configured to set the duplex printing locations on the front and back pages according to the designated printing locations of the preview image as moved thereto by the user.

5. The apparatus of claim 1, wherein the printing location setter is configured to set the duplex printing locations on the front and back pages according to designated printing location values as set thereto by the user.

6. A method of duplex printing using a preview function, comprising the steps of:
generating a preview image of front and back pages prepared by a user;
setting printing locations on the front and back pages on which duplex printing is to be performed according to printing locations designated using the preview image;
coding images of the front and back pages; and
converting the coded data into bitmap image data and duplex printing the bitmap image data.

7. The method of claim 6, further comprising the step of:
distinguishing and outputting the front and back pages on which duplex printing is to be performed as one preview image.

8. The method of claim 6, further comprising the step of:
distinguishing and outputting the front and back pages on which duplex printing is to be performed as different preview images.

9. The method of claim 6, further comprising the step of:
setting the duplex printing locations on the front and back pages according to the designated printing locations of the preview image as moved thereto by the user.

10. The method of claim 1, further comprising the step of:
setting the duplex printing locations on the front and back pages according to designated printing location values as set thereto by the user.

11. A computer-readable recording medium on which a program is recorded to execute the method of claim 6.

12. A computer readable medium of instructions for providing duplex printing using a preview function comprising:
a first set of instructions adapted to generate a preview image of front and back pages prepared by a user;
a second set of instructions adapted to set printing locations on the front and back pages on which duplex printing is to be performed according to printing locations that a user designates using the preview image;
a third set of instructions adapted to code images of the front and back pages; and
a fourth set of instructions adapted to convert the coded data into bitmap image data and duplex printing the bitmap image data.

13. The computer readable medium of instructions of claim 12, wherein the first set of instructions are further adapted to distinguish and output the front and back pages on which duplex printing is to be performed as one preview image.

14. The computer readable medium of instructions of claim 12, wherein the first set of instructions are further adapted to distinguish and output the front and back pages on which duplex printing is to be performed as different preview images.

15. The computer readable medium of instructions of claim 12, wherein the second set of instructions are further adapted to set the duplex printing locations on the front and back pages according to the designated printing locations of the preview image as moved thereto by the user.

16. The computer readable medium of instructions of claim 12, wherein the second set of instructions are further adapted to set the duplex printing locations on the front and back pages according to designated printing location values as set thereto by the user.
